(19) United States
(12) Patent Application Publication
(10) Pub. No.: US 2016/0282886 A1
(43) Pub. Date: Sep. 29, 2016

(54) UPPER DOME TEMPERATURE CLOSED LOOP CONTROL

(71) Applicant: Applied Materials, Inc., Santa Clara, CA (US)

(72) Inventors: Jamie Stuart LEIGHTON, Palo Alto, CA (US); Carlos CABALLERO, Diamond Bar, CA (US); Shin KITAMURA, Chiba (JP); Thomas ACKERMAN, Feichten (DE); Mark AUZENNE, Point Arena, CA (US); Vivek VINIT, Bangalore (IN)

(21) Appl. No.: 14/722,327

(22) Filed: May 27, 2015

(30) Foreign Application Priority Data
Mar. 27, 2015 (IN) 1585/CHE/2015

(51) Int. Cl. G05D 23/19; G05B 11/42

(52) U.S. Cl. CPC G05D 23/1917; G05B 11/42

(57) ABSTRACT

A method and apparatus for controlling the temperature in a processing chamber for semiconductor processing is disclosed herein. In one embodiment, a processing chamber for semiconductor processing is provided. The processing chamber includes a chamber body and a temperature control system. The temperature control system includes a temperature sensor configured to measure a temperature in an upper dome of the processing chamber, a blower, and a controller configured to control the temperature control system. The temperature control system is configured to carry out the method provided herein for controlling the temperature in a processing chamber.

### CROSS-REFERENCE TO RELATED APPLICATIONS

This application claims priority from India Provisional Application No. 1585/CHE/2015, filed Mar. 27, 2015, which is hereby incorporated by reference in its entirety.

### FIELD

The present disclosure generally relates to a method and apparatus for controlling the temperature of components of a semiconductor processing apparatus. More specifically, a temperature control system implementing a PID controller communicating with a temperature sensor and a variable speed blower is described herein.

### BACKGROUND

One type of processing apparatus for semiconductor substrates is a single substrate processor in which one substrate at a time is supported on a susceptor in a processing chamber. The susceptor divides the chamber into two regions: an upper region bounded by an upper dome, which is above the susceptor, and a lower region bounded by a lower dome, which is below the susceptor. The susceptor is generally mounted on a shaft, which rotates the susceptor about its center to enhance uniform processing of the substrate. A flow of a processing gas is provided in the top of the chamber to process the surface of the substrate. The chamber may have a gas inlet port at one side thereof, and a gas outlet port at an opposite side to achieve a flow of the processing gas across the substrate. Alternatively, the upper dome may incorporate a gas distributor to direct process gases toward the substrate, with gases exiting at a periphery of the chamber.

The susceptor may be heated in order to heat the substrate to a desired processing temperature. One method used to heat the susceptor is by the use of lamps provided around the chamber. The lamps direct thermal radiation into the chamber and onto the susceptor and/or the substrate. One or more of the lamps may direct radiation through the upper dome. The temperature of the susceptor and/or the substrate may be constantly measured to control the temperature to which the substrate is being heated. The temperature may be measured using a temperature sensor to detect thermal radiation emitted from the substrate. Such temperature sensors are frequently positioned outside the processing environment of the chamber to avoid adverse effects on the temperature sensors. In one arrangement, the temperature sensor is positioned to view radiation emitted by the substrate through the upper dome. In such arrangements, the upper dome is made of a material that is substantially transparent to the radiation detected by the temperature sensor. The substrate temperature is controlled to afford uniform processing of substrates in the chamber. Temperature non-uniformities may lead to slip lines, stacking faults, particle generation, and defects in the substrate.

In most cases, a surface of the upper dome that faces the substrate is exposed to the processing environment. Where substrate temperature control depends on radiation being transmitted through the upper dome, either from the substrate to a detector or from a lamp to the substrate, steps are taken to prevent deposition of process gases on the process-facing surface of the upper dome.

It has been determined that maintaining the upper dome at a low temperature is a key factor in preventing film growth on the upper dome. Thus, there is a need to control the temperature of the upper dome for preventing film growth.

### SUMMARY

In one embodiment, a processing chamber for semiconductor processing is disclosed herein. The processing chamber includes a chamber body and a temperature control system. The chamber body includes an upper dome and a lower dome. The upper dome and the lower dome define an interior volume of the processing chamber. The temperature control system includes a temperature sensor, a blower, and a controller. The temperature sensor is configured to measure a temperature in the upper dome. The controller is configured to control the temperature control system. The controller communicates with the blower and the temperature sensor.

In another embodiment, a temperature control system is disclosed herein. The temperature control system includes a temperature sensor, a blower, and a controller. The temperature sensor is configured to measure a temperature in the upper dome. The controller is configured to control the temperature control system. The controller communicates with the blower and the temperature sensor.

In another embodiment, a method for controlling the temperature in a processing chamber for semiconductor processing is disclosed herein. The temperature of an upper dome of the processing chamber is measured using a temperature sensor. The measured temperature is transmitted from the temperature sensor to a PID controller. The PID controller calculates a controller output based on the measured temperature. A cooling mechanism is provided from the variable speed blower in communication with the PID controller.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a cross sectional view of one embodiment of a processing chamber.

FIG. 2 illustrates one embodiment of the temperature control system of the processing chamber in FIG. 1.

FIG. 3 illustrates one embodiment of a method for cooling the upper dome of the processing chamber of FIG. 1 using the temperature control system of FIG. 2.

FIG. 4 illustrates one embodiment of the control for the PID controller.

For clarity, identical reference numerals have been used, where applicable, to designate identical elements that are common between figures. Additionally, elements of one embodiment may be advantageously adapted for utilization in other embodiments described herein.

### DETAILED DESCRIPTION

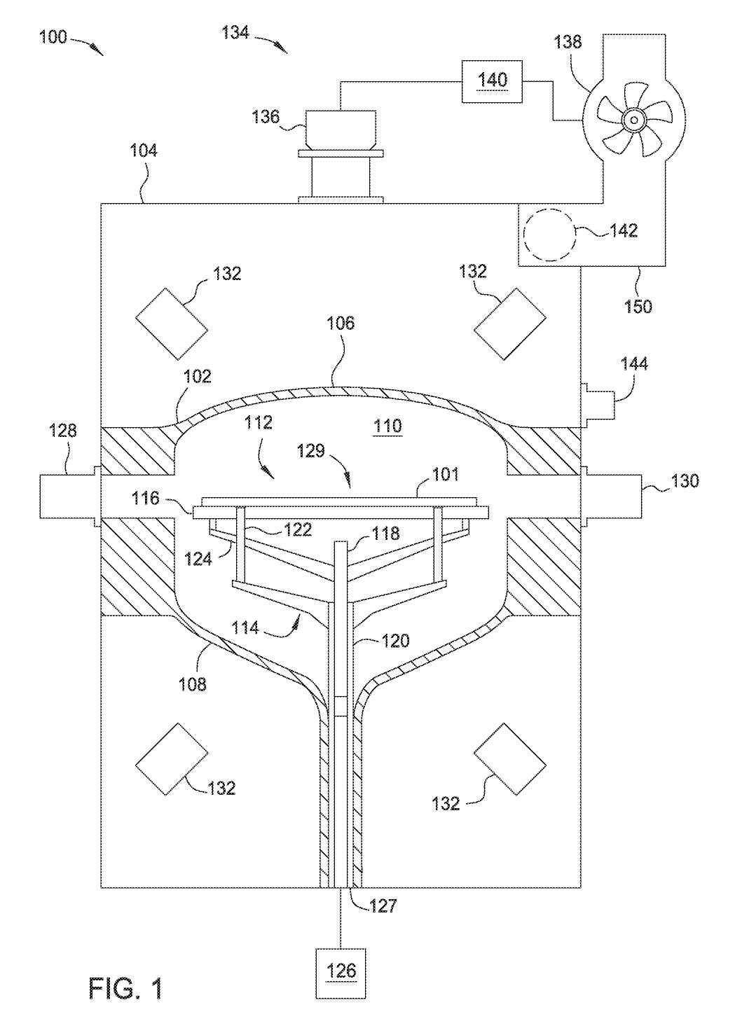

FIG. 1 illustrates a cross sectional view of a processing chamber 100 for processing a substrate 101 according to one embodiment. The processing chamber 100 includes a chamber body 102, a housing 104, and a temperature control system 134. The housing 104 envelopes and supports the chamber body 102. The chamber body 102 includes an upper dome 106 and a lower dome 108. The upper dome 106 and the lower dome 108 define the interior volume 110 of the processing chamber 100. A substrate support assembly 112 is positioned in the interior volume 110 of the chamber body 102.

The substrate support assembly 112 includes a support shaft system 114 and a susceptor 116. The support shaft system 114 includes a shaft 118, a shroud 120, a plurality of lift pins 122, and a plurality of arms 124. The shaft 118 of the support shaft system 114 is positioned within the shroud 120, and both the shaft 118 and the shroud 120 extend through an opening 127 in the lower dome 108. The shaft 118 and shroud 120 extend outside the housing 104. The shaft 118 and shroud 120 may be coupled to an actuator assembly 126. The actuator assembly 126 may be configured to rotate the shaft 118 on a central axis and to move the shaft 118 and the shroud 120 along an axis of the chamber 100. The shroud 120 generally does not rotate during processing.

The plurality of arms 124 is coupled to the shaft 118. The arms 124 extend out radially to support the susceptor 116. The lift pins 122 are configured to extend through the susceptor 116 to raise or lower the substrate 101. The lift pins 122 may be coupled to the shroud 120 to provide movement for the lift pins 122. An actuator of the actuator assembly 126 may move the shroud 120, and the lift pins 122 coupled to the shroud 120, in an axial direction to raise or lower the substrate 101.

During processing, gases enter the processing chamber 100 through an entry port 128 formed in the chamber body 102. The gases are removed through an exhaust port 130 formed in the chamber body 102. The gases flow into the interior volume 110 of the chamber 100. A process-facing surface 129 of the upper dome 106, which faces the substrate 101, is frequently exposed to the processing environment and the process gases flowing through the interior volume 110.

Heat sources 132 are disposed within the housing 104, outside the chamber body 102. The heat sources 132 may be, for example, radiation bulbs. The heat sources 132 are configured to provide heat to the chamber body 102. The upper dome 106 and the lower dome 108 are made from a transparent material, e.g. quartz. The transparent material allows heat from the heat sources 132 to freely enter the processing chamber 100 to heat the substrate 101. In some embodiments, a temperature sensor 136 may be positioned outside the upper dome 106 and oriented toward the susceptor 116 to view thermal radiation emitted by a substrate during processing.

During processing, a film (not shown) may form on the upper dome 106. The film may block the heat emitted from the heat sources 132 from entering the processing chamber 100 and/or radiation from a substrate reaching the temperature sensor 136. As a result, there may be temperature instability within the interior volume 110. Temperature instability may lead to slip lines, stacking faults, particles, and defects on the substrate 101. It has been determined that maintaining the upper dome 106 at a fixed temperature is a factor in preventing film growth on the upper dome 106. The fixed temperature is determined by chemical characteristics of process gases flowed into the chamber 100, but in most cases, the desired temperature control range is: 450 degrees Celsius to 650 degrees Celsius.

To prevent a film from forming on the upper dome 106, the upper dome 106 may be cooled by the temperature control system 134. The temperature control system 134 includes a temperature sensor 136, which may be a pyrometer, a variable speed blower 138, and a controller 140. The variable speed blower 138 provides a cool gas flow via a conduit 150, directed through the housing 104. More specifically, the gas flow is supplied via the conduit 150 to the housing 104 through an inlet port 142. The gas flow may exit the housing 104 via an exhaust port 144. The cool gas entering through the inlet port 142 passes across the upper dome 106 and exits the housing 104 through the exhaust port 144. The constant flow of cool gas along the top surface of the upper dome 106 cools the upper dome 106 of the chamber body 102. The gas used to cool the dome may be any convenient gas. In some cases, air may be used. The gas is typically selected to be chemically inert in the environment adjacent to the upper dome 106 outside the interior volume 110. Examples of gases that may be used include nitrogen, helium, argon, and combinations thereof.

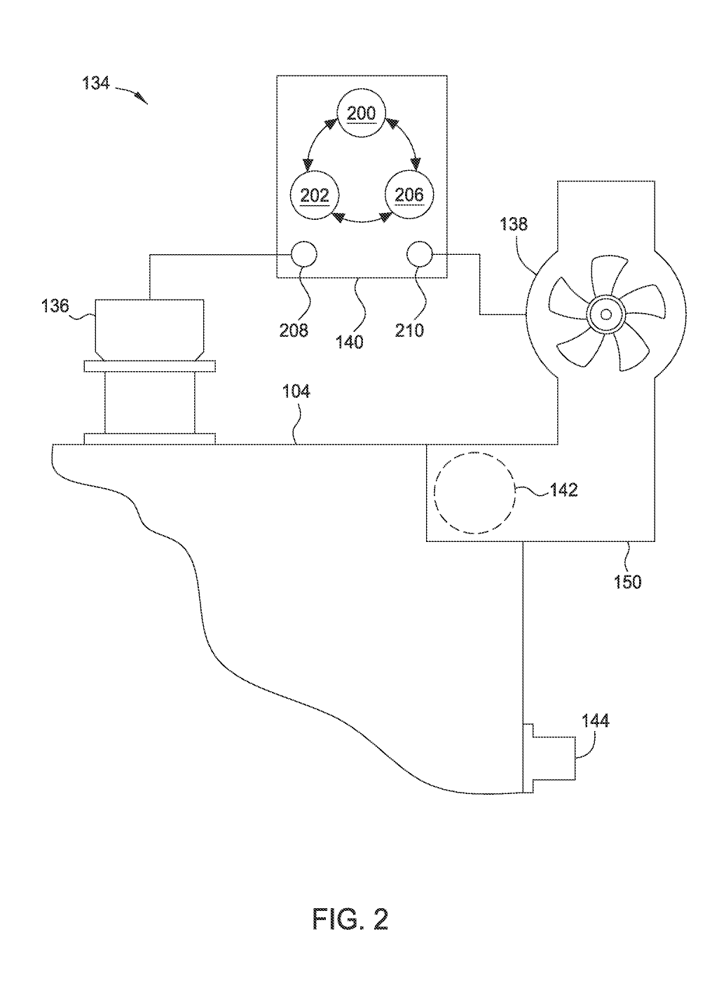

FIG. 2 is an enlarged view of the temperature control system 134. The temperature of the upper dome 106 may be monitored using the temperature sensor 136. The temperature sensor 136 may be made of quartz. The temperature sensor 136 uses light having a wavelength of about 1.5 μm to about 6 μm to measure the temperature of the upper dome 106. The temperature sensor 136 is connected to the controller 140. The controller 140 may be, for example, a PID controller.

The PID controller 140 may be used to operate all aspects of the temperature control system 134. The PID controller 140 includes a programmable central processing unit (CPU) 200 that is operable with a memory 202 and a mass storage device, an input control unit, and a display unit (not shown), such as power supplies, clocks, cache, input/output (I/O) circuits, and the like, coupled to the various components of the temperature control system 134 to facilitate control of the variable speed blower 138. The PID controller 140 also includes hardware for monitoring the temperature sensor 136. The PID controller 140 may also be coupled to additional sensors that measure system parameters such as substrate temperature, chamber atmosphere pressure and the like.

To facilitate operation of the temperature control system 134 described above, the CPU 200 may be one of any form of general purpose computer processor that can be used in an industrial setting, such as a programmable logic controller (PLC), for controlling the variable speed blower 138 based on data from the temperature sensor 136. The memory 202 is coupled to the CPU 200. The memory 202 is non-transitory and may be one or more readily available memory types such as random access memory (RAM), read only memory (ROM), floppy disk drive, hard disk, or any other form of digital storage, local or remote. Support circuits 206 are coupled to the CPU 200 for supporting the processor in a conventional manner. Process information is generally stored in the memory 202, typically as a software routine. The software routine may also be stored and/or executed by a second CPU (not shown) that is remotely located from the hardware being controlled by the CPU 200.

The memory 202 is in the form of computer-readable storage media that contains instructions, that when executed by the CPU 200, facilitates the operation of the temperature control system 134. The instructions in the memory 202 are in the form of a program product such as a program that implements the method of the present disclosure. The program product contains program code that may conform to any one of a number of different programming languages. In one example, the methods described herein may be implemented as a program product stored on a computer-readable storage media for use with a computer system. The program(s) of the program product define functions of the embodiments (including the methods described herein). Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the methods described herein, are embodiments of the present disclosure.

The PID controller 140 also includes an input 208 and an output 210. The temperature sensor 136 is connected to the PID controller 140 via the input 208. The output 210 of the PID controller 140 is connected to the variable speed blower 138. The variable speed blower 138 blows gas to the surface of the upper dome 106 to prevent the upper dome 106 from overheating. The variable speed blower 138 may be set to a percentage of the total power of the variable speed blower 138.

Because not all variable speed blowers 138 operate with the same efficiency level for blowing cool gas, using a direct measurement of the upper dome temperature to adjust the speed of the variable speed blower 138 can compensate for differences among the variable speed blowers. To ensure that any variable speed blower 138 can be outfitted to the housing 104, a control loop feedback mechanism in the form of a PID controller 140 is implemented.

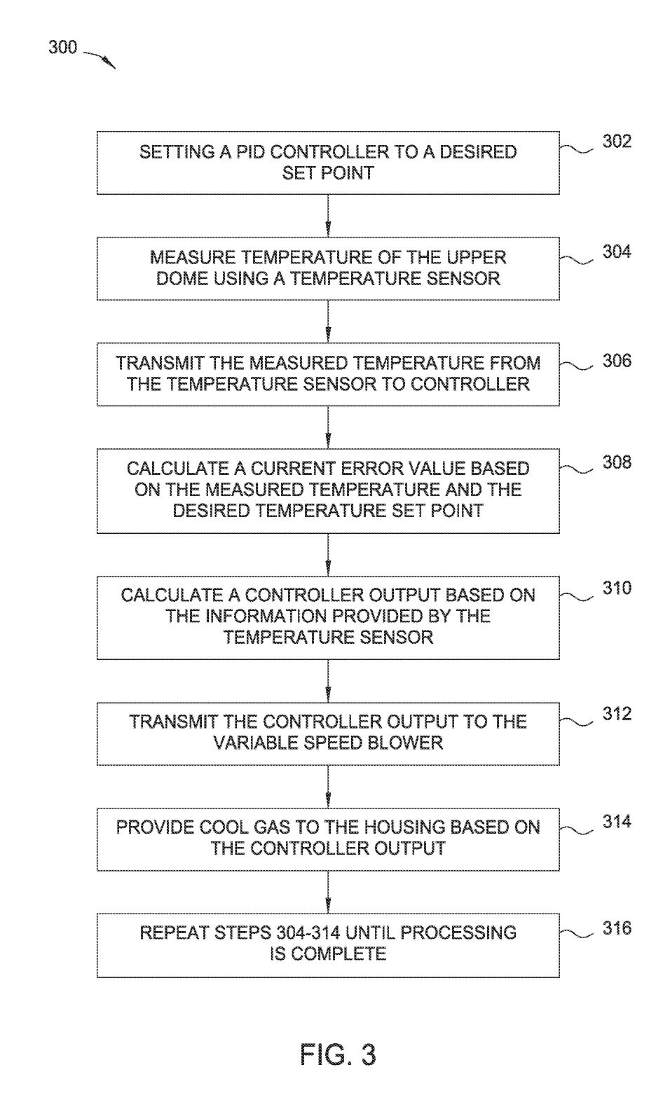

FIG. 3 illustrates a method 300 for controlling the temperature of an upper dome 106 using the PID controller 140. At block 302, the PID controller 140 is set to a desired temperature set point. The desired temperature set point is that temperature at which a film will not form on the upper dome 106 during processing of a substrate 101. For example, the desired temperature set point of the upper dome 106 may be 510 degrees Celsius when the process temperature is 1100 degrees Celsius. In another embodiment, the desired temperature set point of the upper dome 106 may be 530 degrees Celsius when the process temperature is 1130 degrees Celsius. The desired temperature set point is stored in the memory 202 of the PID controller 140.

At block 304, the temperature of the upper dome 106 is measured using the temperature sensor 136. The temperature sensor 136 may be a quartz pyrometer. The temperature sensor 136 may operate using light having a wavelength of about 1.5 μm to about 6 μm, for example about 5 μm, to measure the temperature of the upper dome 106.

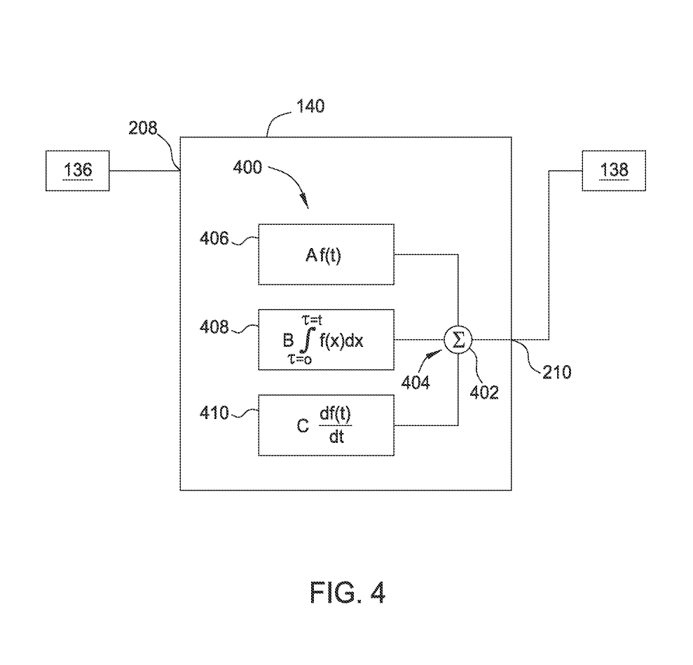

At block 306, the temperature sensor 136 transmits the measured temperature of the upper dome 106 to the input 208 of the PID controller 140. The PID controller 140 calculates a controller output 402 based on the information provided by the temperature sensor 136. FIG. 4 illustrates one embodiment of the control logic 400 of the PID controller 140. A controller output 402 is calculated using a summation 404 of a proportional gain 406, an integral gain 408, and a derivative gain 410. The proportional gain 406 represents an output value that is proportional to a current error value. The current error value is calculated in block 308. The current error value is the difference between the measured temperature (MT) and the temperature set point (TSP) at a certain time, t, i.e.

f(t)=MT−TSP

Thus, the proportional gain 406 is represented by the equation:

Proportional Gain=Af(t)=A(MT−TSP)

where A is a constant.

The integral gain 408 represents an output in the form of an integral term that is proportionate to the magnitude of the error and the duration of the error. The integral gain 408 may be represented by the equation:

Integral Gain=B∫f(x)dx, from x=0 to x=t

where B is also a constant.

The derivative gain 410 is calculated by determining the slope of the error over time. The slope of the error over time is then multiplied by a constant, C. The derivative gain 410 may be represented by the equation:

Derivative Gain=Cd/dtf(t)

Referring back to FIG. 3, at block 310 the PID controller 140 calculates the controller output 402. The controller output 402 is represented by the equation:

Output=Proportional Gain+Integral Gain+Derivative Gain

The constants A, B, and C determine the relative contribution of proportional gain, integral gain, and derivative gain to the controller output 402.

At block 312, the PID controller 140 transmits a controller output 402 from the output 210 of the PID controller 140 to the variable speed blower 138.

At block 314, the variable speed blower 138 provides cool gas to the housing 104, in response to the controller output 402. The controller output 402 adjusts the total power of the variable speed blower 138 to a percentage of the total power. The cool gas flows through the conduit 150 and enters the housing 104 via the inlet port 142. The cool gas then flows over the top surface of the upper dome 106. The cool gas exits the housing 104 via the outlet.

At block 316, the method from block 304 to block 314 is repeated until processing of the substrate 101 is complete. The advantage of the closed loop control feedback system is that the system removes many variables that can impact the actual upper dome 106 temperature, such as, but not limited to, variations in blower efficiency, variable speed blower conduit leaks, and variations in overall cooling in the system. As a result, more substrates may be processed between chamber cleanings, thus increasing the overall efficiency of the processing system.

While the foregoing is directed to specific embodiments, other and further embodiments may be devised without departing from the basis scope thereof, and the scope thereof is determined by the claims that follow.

What is claimed is:

1. A processing chamber for semiconductor processing, the processing chamber comprising:
a chamber body comprising:
an upper dome;
a lower dome, the upper dome and the lower dome defining an interior volume of the processing chamber; and
a temperature control system comprising:
a temperature sensor to measure a temperature of the upper dome;
a blower; and
a controller in communication with the blower and the temperature sensor.

2. The processing chamber of claim 1, wherein the temperature sensor is a pyrometer.

3. The processing chamber of claim 1, wherein the temperature sensor uses light having a wavelength between 1.5 um to 6 um to measure the temperature of the upper dome.

4. The processing chamber of claim 1, wherein the controller is a PID controller.

5. The processing chamber of claim 4, wherein the PID controller is set to a desired temperature set point such that a film will not form on the upper dome during processing.

6. The processing chamber of claim 1, wherein the controller comprises:
an input coupled to the temperature sensor; and
an output coupled to the blower.

7. The processing chamber of claim 1, wherein the blower is operable to provide a cool gas flow to the upper dome.

8. The processing chamber of claim 1, wherein the temperature sensor is operable to transmit a measured temperature of the upper dome to the controller.

9. A temperature control system for a processing chamber for semiconductor processing, the temperature control system comprising:
a temperature sensor to measure a temperature of a process-exposed component of the processing chamber;
a blower to direct a cooling gas flow toward the process-exposed component; and
a controller in communication with the blower and the temperature sensor.

10. The temperature control system of claim 9, wherein the temperature sensor is a pyrometer.

11. The temperature control system of claim 9, wherein the temperature sensor uses light having a wavelength between 1.5 μm to 6 μm to measure the temperature of the upper dome.

12. The temperature control system of claim 9, wherein the controller is a PID controller.

13. The temperature control system of claim 12, wherein the PID controller is set to a desired temperature set point such that a film will not form on the upper dome during processing.

14. The temperature control system of claim 9, wherein the controller comprises:
an input coupled to the temperature sensor; and
an output coupled to the blower.

15. The temperature control system of claim 9, wherein the blower directs cooling gas toward an upper dome of the processing chamber.

16. The temperature control system of claim 9, wherein the temperature sensor is operable to transmit a measured temperature of the upper dome to the controller.

17. A method for controlling the temperature in a processing chamber for semiconductor processing, the method comprising:
measuring a temperature of an upper dome of the processing chamber using a temperature sensor;
transmitting the measured temperature from the temperature sensor to a PID controller;
calculating a controller output based on the measured temperature;
operating a blower based on the controller output to control the temperature of the upper dome.

18. The method of claim 17, wherein measuring a temperature of an upper dome of the processing chamber using a temperature sensor comprises:
measuring the temperature of the upper dome of the processing chamber using light having a wavelength between 1.6 μm to 6 μm.

19. The method of claim 17, further comprising:
setting the PID controller to a desired temperature set point.

20. The method of claim 19, wherein calculating a controller output based on the measured temperature comprises:
comparing the measured temperature to the desired temperature set point.
